(19) United States
(12) Patent Application Publication
(10) Pub. No.: US 2009/0268188 A1
(43) Pub. Date: Oct. 29, 2009

(54) EXPOSURE APPARATUS AND DEVICE MANUFACTURING METHOD

(75) Inventors: Seima Kato, Utsunomiya-shi (JP); Chidane Ouchi, Utsunomiya-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/419,194

(22) Filed: Apr. 6, 2009

(30) Foreign Application Priority Data
Apr. 10, 2008 (JP) 2008-102625

(51) Int. Cl. G03B 27/72

(52) U.S. Cl. 355/71

(57) ABSTRACT

An exposure apparatus includes an illumination optical system. The illumination optical system includes a first member configured to define an illuminated region of a reflective mask having a pattern to be projected onto a substrate; a second member configured to define an illuminated region in which a measurement pattern used in measuring wavefront aberration of a projection optical system is illuminated, the second member being able to be inserted into and removed from an optical path of the illumination optical system; and a condensing mirror configured to condense light from the first member on the pattern to be projected onto the substrate and light from the second member on the measurement pattern. The illuminated region defined by the second member is smaller than the illuminated region defined by the first member.

### BACKGROUND OF THE INVENTION

1. Field of the Invention

The present invention generally relates to exposure apparatuses and device manufacturing methods.

2. Description of the Related Art

Semiconductor devices and the like are manufactured photolithographically. Photolithography is performed by using an exposure apparatus, in which a pattern on an original (a mask or a reticle) is projected through a projection optical system to a substrate (a wafer).

Particularly in recent years, exposure apparatuses employing extreme ultraviolet (EUV) light, whose wavelength is about 1/10 of ultraviolet light employed in earlier exposure apparatuses, have been being developed so that line widths of device patterns can be made much finer. The wavelength λ of EUV light ranges from about 10 to 15 nm (for example, 13.5 nm). Since EUV light having such a wavelength is largely absorbed by matter, a dioptric system cannot be used as a projection optical system. Instead, a catoptric system is used. The wavefront aberration of the projection optical system needs to be, in accordance with Marechal's criterion, λ/14 (=0.96 nm) rms or less. To realize accurate aberration measurement of such a projection optical system in the exposure apparatus, a highly accurate measurement technique in which a much smaller aberration, i.e., about several tenths of the wavefront aberration of the projection optical system, can be resolved is required.

Exemplary interferometers capable of measuring the wavefront of the projection optical system with high accuracy include a lateral shearing interferometer (see Japanese Patent Laid-Open No. 2005-159213, Japanese Patent Laid-Open No. 2006-332586, and Japanese Patent Laid-Open No. 2006-303370).

In the measurement by using the lateral shearing interferometer, a pinhole mask having a pinhole is provided in an object plane of a projection optical system (a to-be-tested optical system). If the pinhole is sufficiently small, the wavefront of light that is output from the pinhole is regarded as an ideal spherical wave and therefore is treated as a reference wavefront. An image of the pinhole is affected by the aberration of only the to-be-tested optical system before being formed on an image plane. A diffraction grating is disposed near the image plane. The diffraction grating shears the wavefront into two directions orthogonal to each other. This produces interference fringes on an observation plane provided on the downstream side with respect to the image plane and the diffraction grating. Pieces of wavefront information obtained from pieces of wavefront data in the respective directions are integrated and reconstructed into two-dimensional wavefront data, whereby the wavefront aberration of the to-be-tested optical system can be measured.

To measure the aberration of the projection optical system included in the exposure apparatus with high accuracy, it is desirable to use a light source and an illumination optical system actually used in exposing a substrate to light. When an exposure light source (such as a laser-produced-plasma (LLP) light source or a discharge-produced-plasma (DPP) light source) is used, since the brightness (illuminance, or the luminous flux per unit area) of the exposure light source is low, the illuminance of light passing through the pinhole is considered to be low. In this respect, Japanese Patent Laid-Open No. 2006-332586 discloses a technique of improving the efficiency for light utilization by providing a plurality of pinholes. Meanwhile, Japanese Patent Laid-Open No. 2006-303370 discloses a technique of improving the brightness by interchanging mirrors in an illumination optical system.

Even in the techniques disclosed in Japanese Patent Laid-Open Nos. 2006-332586 and 2006-303370, since the directivity of light from the exposure light source is low, it is difficult to cause the light to selectively condense on the pinhole. If a light-absorbing layer, a region excluding the pinhole, of the pinhole mask is irradiated with light, an appropriate signal-noise (S/N) ratio to be used in the measurement may not be obtained because of a very small amount of reflection from the light-absorbing layer. As a result, interference fringes contain high noise, and the wavefront aberration of the to-be-tested optical system cannot be measured with high accuracy. This is because the area of an illuminated region of the light-absorbing layer of the pinhole mask used for aberration measurement is large relative to the area of the pinhole.

### SUMMARY OF THE INVENTION

The present invention provides an exposure apparatus in which wavefront aberration of a to-be-tested optical system can be measured with high accuracy.

According to an aspect of the present invention, an exposure apparatus includes an illumination optical system configured to illuminate a reflective mask with light from a light source, and a projection optical system configured to project an image of a pattern provided on the reflective mask onto a substrate. The illumination optical system includes a first illuminated-region-defining member configured to define an illuminated region of the reflective mask having the pattern to be projected onto the substrate; a second illuminated-region-defining member configured to define an illuminated region in which a measurement pattern used in measuring wavefront aberration of the projection optical system is illuminated, the second defining member being able to be inserted into and removed from an optical path of the illumination optical system; and a condensing mirror configured to condense the light from the first defining member on the pattern to be projected onto the substrate and the light from the second defining member on the measurement pattern. The illuminated region defined by the second defining member is smaller than the illuminated region defined by the first defining member.

Other features and aspects of the present invention will be apparent from the following description taken in conjunction with the accompanying drawings, in which like reference characters designate the same or alternatively similar parts throughout the figures thereof.

### BRIEF DESCRIPTION OF THE DRAWINGS

The accompanying drawings, which are incorporated in and constitute a part of the specification, illustrate embodiments of the present invention and, together with the description, serve to explain the principles of the invention.

FIG. 1 shows an exposure apparatus in a state where a wafer is exposed to light.

FIG. 2 shows the exposure apparatus in a state where wavefront aberration is measured.

FIG. 3 shows an exposure-use field stop.

FIG. 4 shows a region of a mask illuminated when the wafer is exposed to light.

FIG. 5 shows a region of the mask illuminated when a reflecting mirror is used.

FIG. 6 shows a measurement-use mask used when wavefront aberration is measured.

FIG. 7 is an enlarged plan view of a measurement pattern.

FIG. 8 is a cross-sectional view of the measurement pattern and a peripheral region therearound.

FIG. 9 shows a measurement-use field stop according to a first embodiment of the present invention.

FIG. 10 is a graph showing the relationship between the illuminated region of the measurement-use mask and the contrast of interference fringes.

FIG. 11 shows a measurement-use field stop according to a second embodiment of the present invention.

FIG. 12 shows the mechanism of the measurement-use field stop according to the second embodiment.

### DESCRIPTION OF THE EMBODIMENTS

Various embodiments of the present invention will now be described in detail with reference to the accompanying drawings.

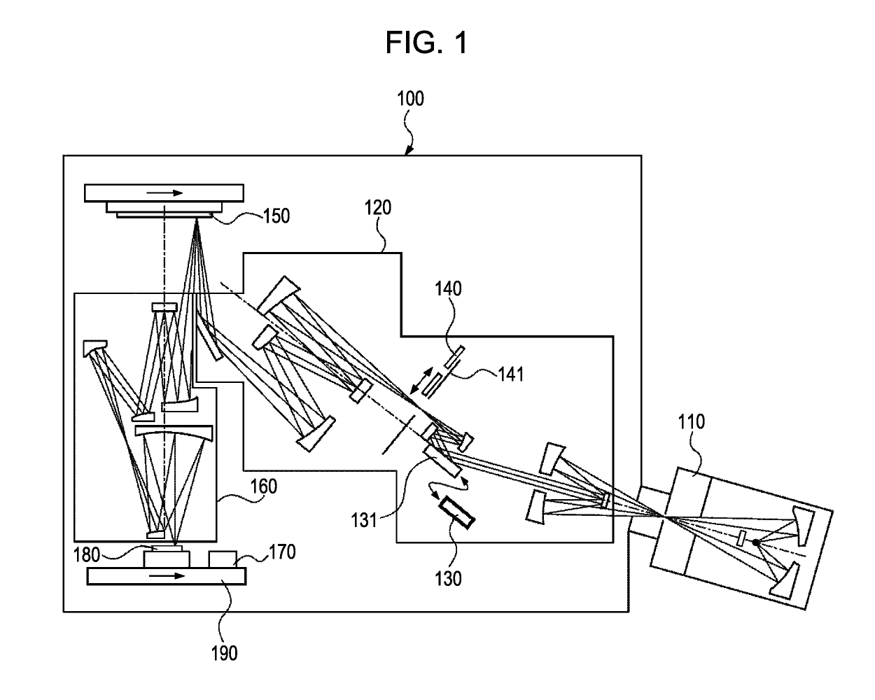

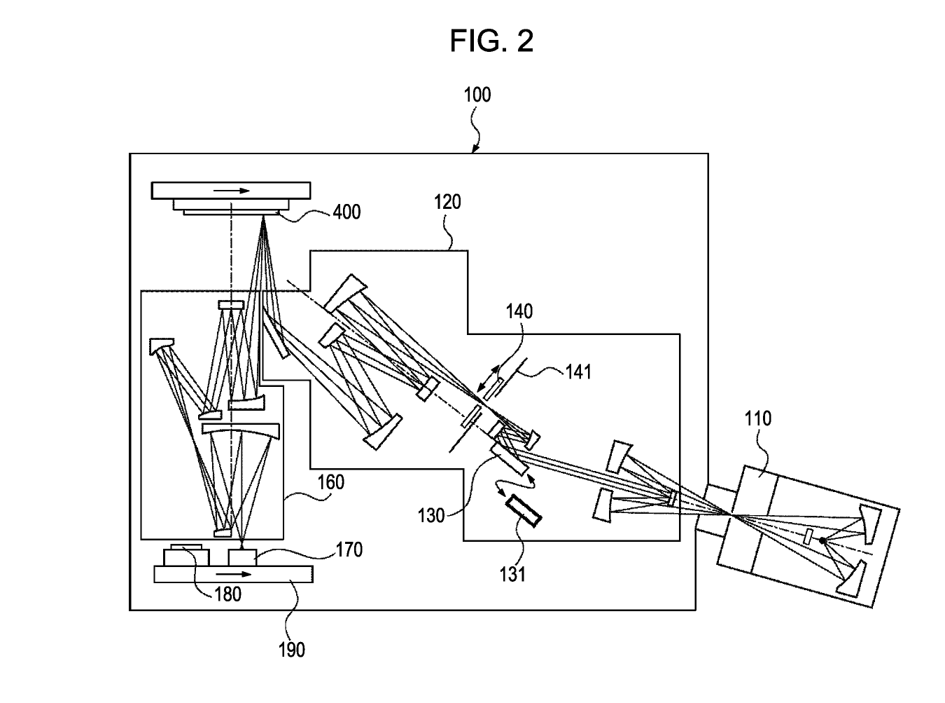

An exposure apparatus 100 according to a first embodiment will now be described with reference to FIGS. 1 and 2. The exposure apparatus 100 includes at least the following elements: an illumination optical system 120, a mask stage, a projection optical system 160, and a wafer stage 190. FIG. 1 shows the exposure apparatus 100 in a state where a reflective mask 150 having a circuit pattern to be projected onto a wafer 180 is illuminated, whereby the pattern is projected through the projection optical system (a to-be-tested optical system) 160 onto the wafer 180. FIG. 2 shows the exposure apparatus 100 in a state where the wavefront aberration of the projection optical system 160 is measured.

Referring to FIG. 1, light emitted from an EUV exposure light source 110 enters the illumination optical system 120, which is a catoptric system. The illumination optical system 120 includes a reflecting mirror 130, a reflective integrator 131, an exposure-use field stop 141 as a first illuminated-region-defining stop, a measurement-use field stop 140 as a second illuminated-region-defining stop, and other catoptric elements.

The illumination optical system 120 provides an intermediate image plane in which the light from the light source 110 is imaged. Either of the exposure-use field stop 141 and the measurement-use field stop 140, which are switchable therebetween, is positioned in the intermediate image plane. Alternatively, both the exposure-use field stop 141 and the measurement-use field stop 140 are positioned in the intermediate image plane. The intermediate image plane is provided at a position conjugate to an object plane of the projection optical system 160. In the case where both the exposure-use field stop 141 and the measurement-use field stop 140 are positioned in the intermediate image plane, the intermediate image plane includes a peripheral region therearound.

The reflecting mirror 130 and the reflective integrator 131 are switchable therebetween such that either of the two can be positioned in the optical path of the illumination optical system 120, near a plane conjugate to the pupil plane of the projection optical system 160.

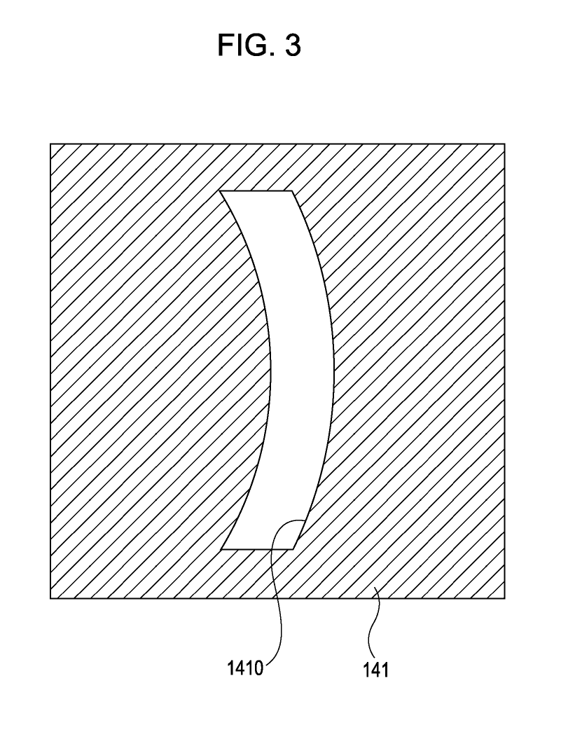

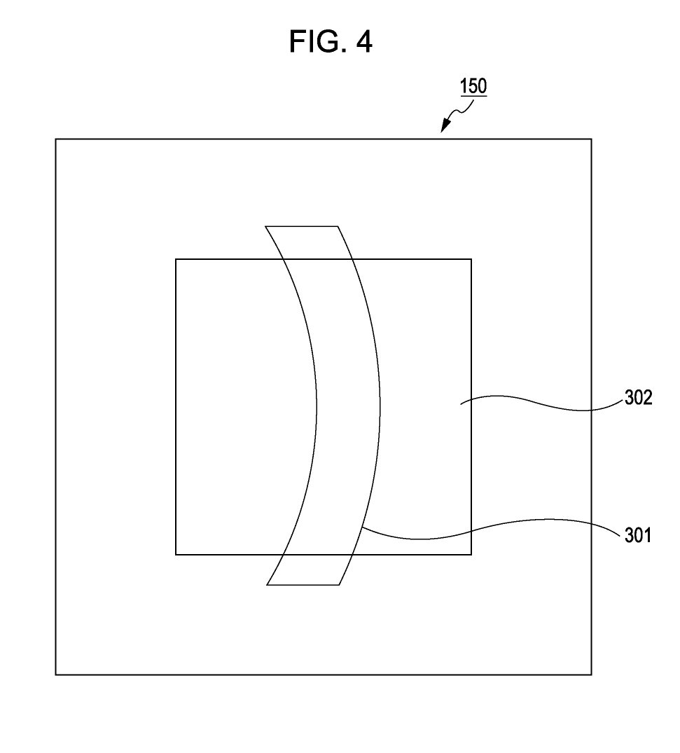

The reflective integrator 131 reflects the EUV light emitted from the light source 110, thereby forming a plurality of secondary light sources. Some of rays from the secondary light sources are blocked by the exposure-use field stop 141, whereby an illuminated region of the mask 150 is defined in an arcuate shape. Referring to FIG. 3, the exposure-use field stop 141 is a light-shielding member (a light-shielding plate) having an arcuate opening 1410. Accordingly, referring to FIG. 4, an arcuate illuminated region 301, defined by the exposure-use field stop 141, of a circuit pattern 302 provided on the mask 150 placed in the object plane (an illumination target plane) of the projection optical system 160 is provided. The exposure-use field stop 141 may be insertable into and removable from the optical path of the illumination optical system 120.

Condensing mirrors provided on the downstream side in the illumination optical system 120 with respect to the exposure-use field stop 141 condense the rays that have been output from the reflective integrator 131 and have passed through the exposure-use field stop 141 on the circuit pattern 302 on the mask 150. Thus, the circuit pattern 302 is illuminated.

The light reflected (diffracted) by the mask 150 illuminated as described above enters the projection optical system 160. The projection optical system 160 projects the image of the pattern 302 on the mask 150 onto a photoresist applied to the wafer 180, by projection exposure at a predetermined magnification. The projection optical system 160 is a catoptric system but is not limited thereto. The same applies to the illumination optical system 120.

Illuminating of the mask 150 and exposure of the wafer 180 are performed while the mask stage holding the mask 150 and the wafer stage 190 holding the wafer 180 are scanningly moved synchronously.

Referring to FIG. 1, when the wafer 180 is exposed to light, the measurement-use field stop 140 retracts from the optical path of the illumination optical system 120 to such a position that the measurement-use field stop 140 does not block the light traveling in the illumination optical system 120. At this time, the reflecting mirror 130 is also positioned off the optical path of the illumination optical system 120. In short, the measurement-use field stop 140, the reflective integrator 131, and the reflecting mirror 130 can be inserted into and removed from the optical path of the illumination optical system 120. The measurement-use field stop 140 can be inserted into and removed from the optical path of the illumination optical system 120, in a plane conjugate to the object plane of the projection optical system 160.

Referring to FIG. 2, the state of the exposure apparatus 100 when the wavefront aberration of the projection optical system 160 is measured will now be described. As can be seen from FIG. 2, when the wavefront aberration of the projection optical system 160 is measured, the measurement-use field stop 140 and the reflecting mirror 130 are positioned in the optical path of the illumination optical system 120. Further, a measurement-use mask 400 is placed in the object plane of the projection optical system 160, and a wavefront-aberration-measuring unit 170 is placed in an exposure area in the image plane (the surface of the wafer 180) of the projection optical system 160. Such switching of optical elements can be realized by using known drive mechanisms.

While the wavefront aberration is measured, the measurement-use field stop 140 blocks some of the light traveling in the illumination optical system 120, thereby defining an illuminated region of the measurement-use mask 400 placed in the object plane of the projection optical system 160. The condensing mirrors provided on the downstream side in the illumination optical system 120 with respect to the measurement-use field stop 140 condense the light that has passed through the measurement-use field stop 140 on a pattern (a measurement pattern) used for wavefront aberration measurement.

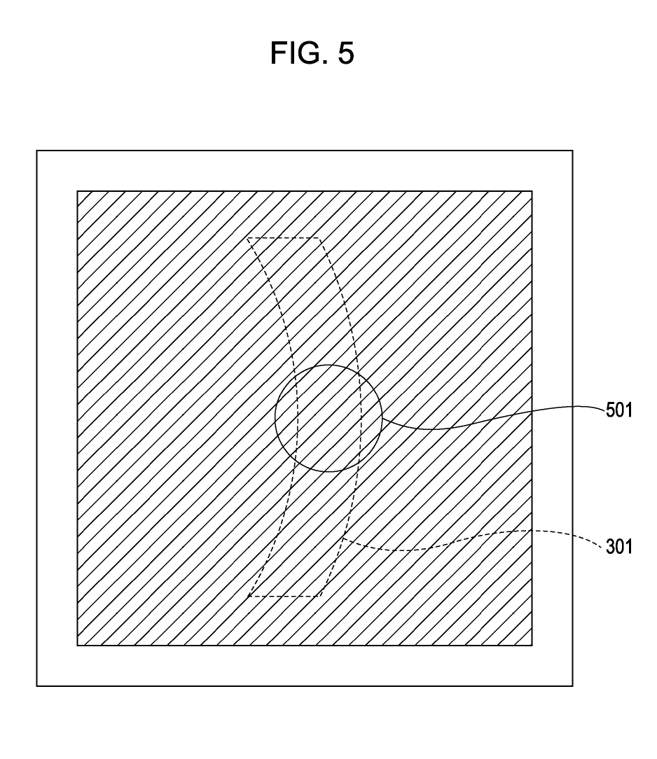

The reflecting mirror 130, which is a flat or curved mirror, reflects the light from the light source 110 without scattering the light. Therefore, when the reflecting mirror 130 is put in the optical path in place of the reflective integrator 131, the illuminated region in the object plane of the projection optical system 160 is switched from the region 301 to a region 501 shown in FIG. 5 if no field stops are placed in the intermediate image plane. Consequently, the brightness of the light illuminating the illumination target plane increases.

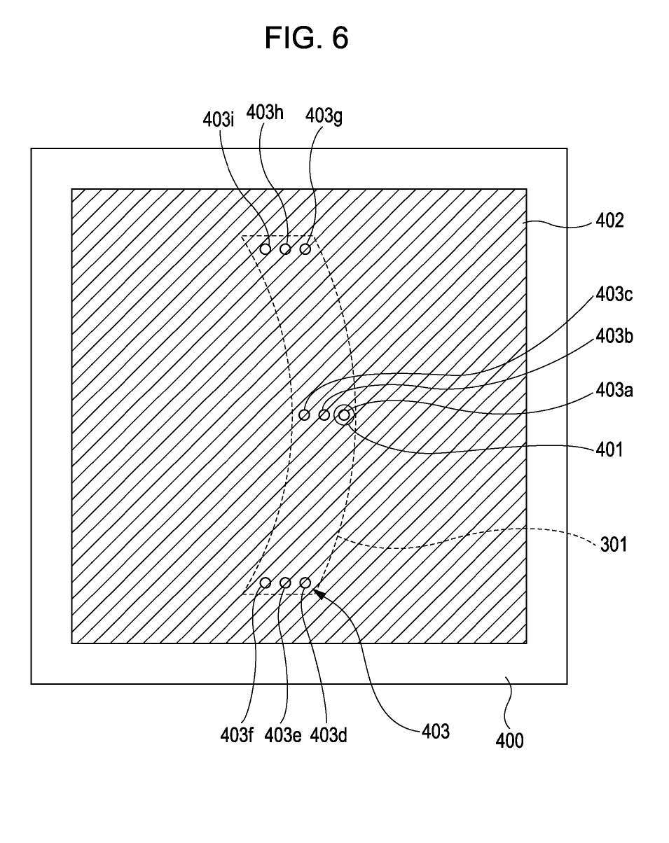

In general, rays that are output from different positions in the region 301 illuminated at the time of exposure produce different aberrations because of difference in the object height (image height) with respect to the optical axis of the projection optical system 160. Considering this, the measurement-use mask 400, which is a reflective mask, shown in FIG. 6 is placed in the object plane of the projection optical system 160, instead of the mask 150. The measurement-use mask 400 has a plurality of measurement patterns 403 (403a to 403i) used for measurement of the wavefront aberration of the projection optical system 160. The region of the measurement-use mask 400 excluding the measurement patterns 403 is covered with a light-absorbing layer 402. The measurement patterns 403 are provided at predetermined object heights in the region 301 illuminated at the time of exposure. While FIG. 6 shows nine measurement patterns 403a to 403i, the number of the measurement patterns 403 is not limited thereto and may vary with the number of positions at which measurements are desired to be taken.

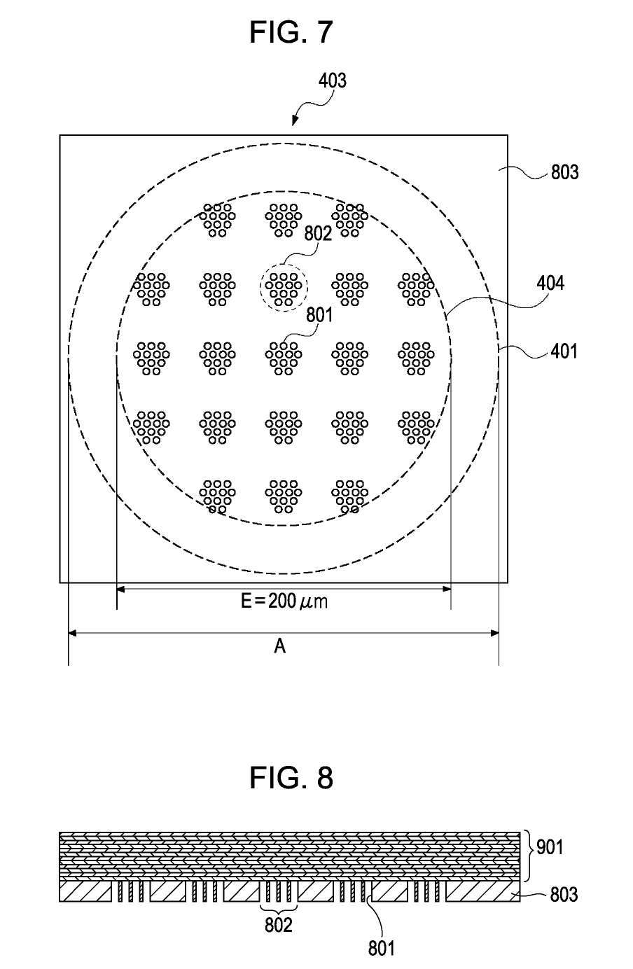

FIG. 7 is a schematic enlarged view of one of the measurement patterns 403. The measurement pattern 403 includes a plurality of pinhole groups 802 each including a plurality of reflective pinholes 801. Referring to FIG. 7, a minimum circle (circumscribed circle) 404 enclosing all of the pinhole groups 802 has a diameter (E) of 200 μm. This means that the pinhole groups 802 are arranged within the diameter of 200 μm. FIG. 8 is a cross-sectional view of the measurement pattern 403 and a peripheral region thereof. The measurement pattern 403 includes, on a substrate (not shown) composed of Si or glass, a reflective layer 901 and a light-absorbing layer 803 adjoining the reflective layer 901. The reflective layer 901 is a multilayer film including Mo and Si layers. The light-absorbing layer 803 absorbs EUV light. Since the light-absorbing layer 803 is required to efficiently absorb EUV light, the light-absorbing layer 803 is desirably composed of TaBN, Ta, Cr, or Ni. If the light-absorbing layer 803 is composed of TaBN, the light-absorbing layer 803 needs to have a thickness of 100 nm or larger.

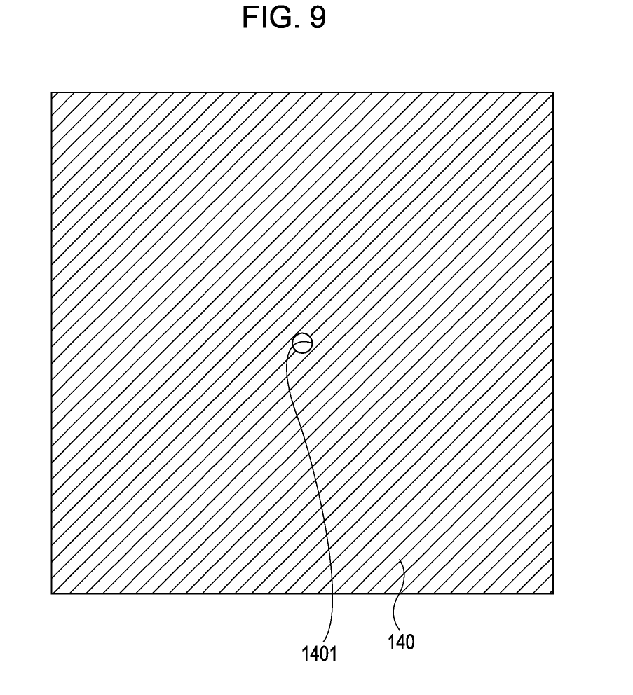

To measure wavefront aberrations of the projection optical system 160 at different object heights independently from each other, referring to FIGS. 6 and 7, the illuminated region 501 needs to be regulated to be an illuminated region 401 so that any of the measurement patterns 403 (for example, 403a) is illuminated. For this reason, the measurement-use field stop 140 that regulates the illuminated region is placed in the optical path near the intermediate image plane in the illumination optical system 120. FIG. 9 shows the measurement-use field stop 140. Light that has passed through an opening (pinhole) 1401 of the measurement-use field stop 140 is regulated so as to illuminate the region 401 of the measurement-use mask 400 placed in the object plane of the projection optical system 160, thereby illuminating the measurement pattern 403a and a peripheral region therearound. The area of the opening (pinhole) 1401 provided in the measurement-use field stop 140 is smaller than the area of the opening 1410 provided in the exposure-use field stop 141. This means that the illuminated region 401 defined by the measurement-use field stop 140 is smaller than the illuminated region 301 defined by the exposure-use field stop 141.

If the illuminated region 401 is large relative to the measurement pattern 403, the rate of very week reflection from the light-absorbing layer 803 is large, generating noise when the wavefront aberration is measured. Therefore, the size of the opening 1401 of the measurement-use field stop 140 is determined such that the size of the illuminated region 401 becomes approximately the same as the size of the measurement pattern 403. Thus, the illuminated region 401 can also be made to fit the measurement pattern 403 exactly.

For example, when a section of the illumination optical system 120 from the intermediate image plane to the illumination target plane produces a magnification M, the diameter of the illuminated region 401 is calculated by multiplying a diameter D of the opening 1401 in the measurement-use field stop 140 by the magnification M. Denoting the diameter of the minimum circle 404 enclosing the measurement pattern 403 (the pinhole groups 802) by E, if settings satisfying D=E/M are made, the size of the illuminated region 401 and the size of the measurement pattern 403 can be made equal.

The diameter (E) of the minimum circle 404 enclosing each of the measurement patterns 403 needs to be limited to such a value that the rays from the measurement patterns 403 produce substantially a uniform aberration after passing through the projection optical system 160. Specifically, such a situation can be realized by setting the diameter E to a value from about 100 μm to 1 mm.

The light reflected by the measurement patterns 403 enters the projection optical system 160, is affected by the wavefront aberration of the projection optical system 160, and is imaged in the image plane of the projection optical system 160.

In the first embodiment, the wavefront-aberration-measuring unit 170 includes a two-dimensional diffraction grating and a detector such as a charge-coupled device. The diffraction grating splits the light that has passed through the projection optical system 160 into two directions perpendicular to the optical axis (the center of the light). Exemplary methods of measuring the wavefront aberration with the foregoing elements are disclosed in Japanese Patent Laid-Open No. 2006-332586 and International Application Published Under The Patent Cooperation Treaty (PCT) bearing International Publication No. WO 2006/115292 A1, each of which is hereby incorporated by reference herein in its entirety.

The two-dimensional diffraction grating, serving as a light splitter, splits the light from the projection optical system 160 into a number of diffracted rays, thereby producing a number of light-condensing points in the image plane of the projection optical system 160. To obtain an interference pattern with high contrast, the interval between the two-dimensional diffraction grating and the image plane is determined such that the Talbot effect can be produced. The detector picks up an image of shearing interference fringes produced by the light from the two-dimensional diffraction grating. Data on the image of interference fringes picked up by the detector is transmitted to an arithmetic unit. The arithmetic unit analyzes (reconstructs) the wavefront and calculates the wavefront aberration of the to-be-tested optical system, i.e., the projection optical system 160. The wavefront is analyzed by, for example, calculating the differential wavefronts in the two respective orthogonal directions defined by the diffraction grating, integrating the differential wavefronts in the two respective directions, and combining the wavefronts.

Next, interference fringes whose image is to be picked up will be described. The pinhole groups 802 are arranged such that the signal intensity of interference fringes produced by the light that has passed through the projection optical system 160 is high. Specifically, the arrangement of the pinhole groups 802 is designed such that the fringe with the highest intensity among interference fringes produced by light from one of the pinhole groups 802 and the fringe with the highest intensity among interference fringes produced by light from another pinhole group 802 overlap each other.

The reflectance of the light-absorbing layer 803 is not zero, that is, the light-absorbing layer 803 does reflect small quantity of light. Therefore, if the quantity of light reflected by the light-absorbing layer 803 increases, the contrast of interference fringes decreases. For example, let us suppose that the diameter E of the minimum circle 404 enclosing the measurement pattern 403 is 200 μm and the reflectance of the light-absorbing layer 803, composed of TaBN, is 0.3%. In this case, if a diameter A (see FIG. 7) of the region 401 illuminated in measuring the wavefront aberration is also 200 μm, the contrast of the interference fringes is 0.47. The diameter A is desirably 200 μm, which is equal to the diameter of a region in which the pinhole groups 802 are arranged. However, the diameter A may be widened because of aberration of the illumination optical system 120.

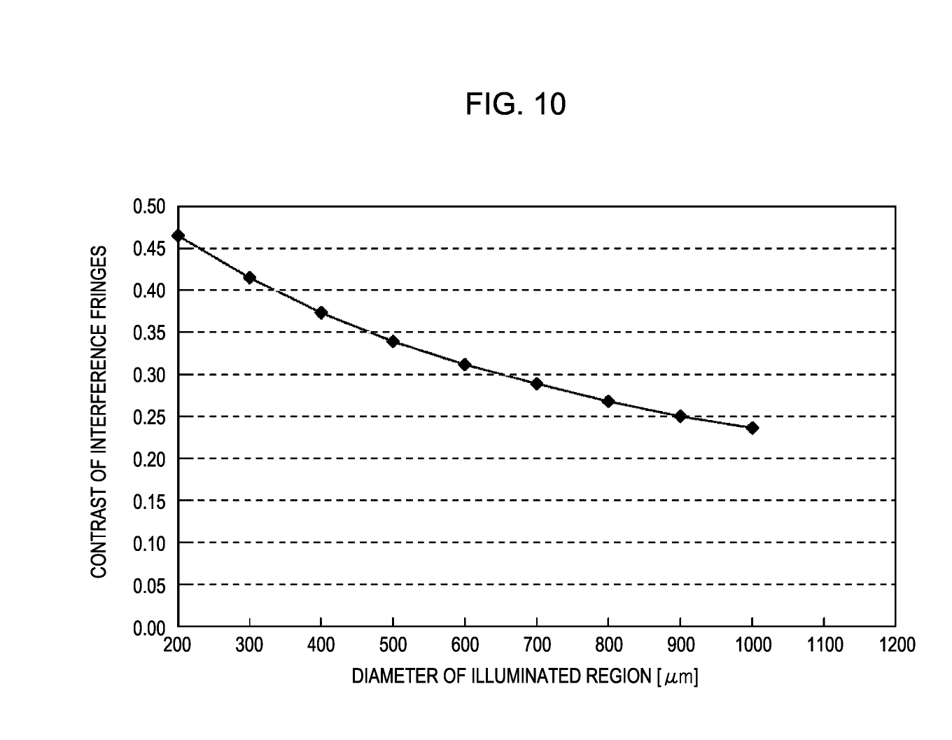

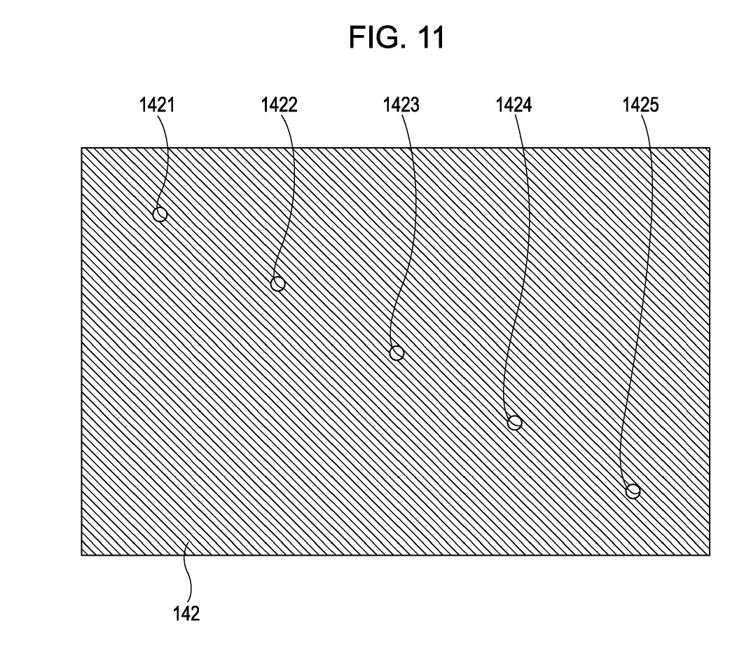

FIG. 10 is a graph showing the relationship between the diameter A of the illuminated region 401 and the contrast of interference fringes. The graph shows that the contrast of interference fringes decreases with increase in the diameter A. The contrast of interference fringes depends on not only the diameter A but also the surface roughness of optical elements included in the illumination optical system 120 and the reflectance of the light-absorbing layer 803. Therefore, if a decrease in the contrast of about 0.05 due to an increase of the diameter A is acceptable, an increase in the diameter A to about 300 μm at the maximum is acceptable. This means that, in a case where aberration of the illumination optical system 120 causes the diameter A to increase, the aberration needs to be regulated such that the enlargement of a light-condensing spot having a diameter of 200 μm results in the diameter not larger than about 300 μm.

To measure wavefront aberrations of the projection optical system 160 at different image heights, the illuminated region 401 needs to be movable so that any of the measurement patterns 403 at a desired image height can be illuminated.

Let us consider a case where, after the illuminated region 501 is defined by the reflecting mirror 130 as shown in FIG. 5 and the wavefront aberration at an image height corresponding to the measurement pattern 403a is measured, the wavefront aberration at an image height corresponding to the measurement pattern 403b is measured. In this case, the measurement-use field stop 140 is moved within the intermediate image plane by using a mechanism configured to move the measurement-use field stop 140, such that the light is applied to the measurement pattern 403b. During the foregoing process, the position of the measurement-use mask 400 is fixed. Subsequently, by using the light reflected by the measurement pattern 403b, the wavefront aberration of the projection optical system 160 at an image height corresponding to the measurement pattern 403b is measured.

Next, a case where the wavefront aberration at an image height corresponding to the measurement pattern 403i is measured will be described. In this case, the reflecting mirror 130 is rotated by a mechanism configured to rotate (move) the reflecting mirror 130, whereby the direction of the light reflected by the reflecting mirror 130 is changed. Specifically, the reflecting mirror 130 can be rotated by any angle with an axis extending in a plane containing the center of the light (the optical axis) serving as the rotational axis. Thus, the illuminated region 501 is shifted so that a region including the measurement pattern 403i can be illuminated. After or synchronously with the rotation of the reflecting mirror 130, the measurement-use field stop 140 is moved within the intermediate image plane such that the light that has passed through the opening 1401 of the measurement-use field stop 140 is applied to the measurement pattern 403i. Subsequently, by using the light reflected by the measurement pattern 403i, the wavefront aberration of the projection optical system 160 at an image height corresponding to the measurement pattern 403i is measured. In this manner, the wavefront aberration of the projection optical system 160 at a given image height can be measured.

While the measurement pattern 403 of the first embodiment is provided on the measurement-use mask 400 provided separately from the mask 150, the measurement pattern 403 is not limited thereto. For example, the measurement pattern 403 may be alternatively provided on the mask 150, whereby the measurement-use mask 400 and the mask 150 are integrated.

According to the first embodiment, since noise generated by light reflected by a light-absorbing layer can be reduced, the wavefront aberration of a to-be-tested optical system can be measured with high accuracy.

Next, a second embodiment of the present invention will be described. The second embodiment differs from the first embodiment in the measurement-use field stop and the mechanism configured to move the measurement-use field stop. Description of elements that are the same or similar to those in the first embodiment are omitted.

FIG. 11 shows a measurement-use field stop 142 according to the second embodiment. The measurement-use field stop 142 is a light-shielding plate in which a plurality of openings (pinholes) 1421 to 1425 are provided. The number of the openings is determined in accordance with the number of positions at which measurements are desired to be taken. The openings are arranged such that only one of the openings is positioned within a region corresponding to the arcuate opening 1410 of the exposure-use field stop 141.

The openings 1421 to 1425 of the measurement-use field stop 142 each have an area smaller than that of the opening 1410 provided in the exposure-use field stop 141. This means that the illuminated region 401 defined by any of the openings 1421 to 1425 of the measurement-use field stop 142 is smaller than the illuminated region 301 defined by the exposure-use field stop 141.

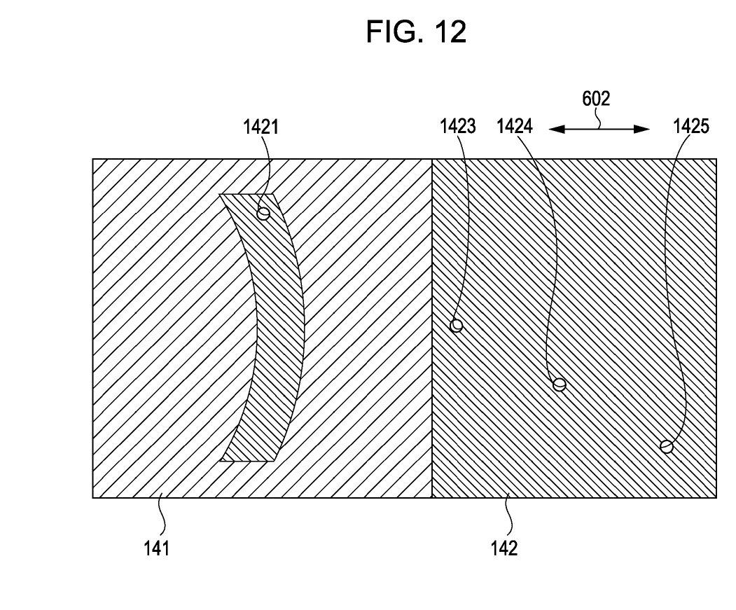

Referring to FIG. 12, a method of measuring wavefront aberrations at different image heights will now be described. FIG. 12 shows the exposure-use field stop 141 and the measurement-use field stop 142 positioned in the intermediate image plane, seen in a direction in which the light is incident thereon. First, the measurement-use field stop 142 is moved by a moving mechanism such that the opening 1421 is positioned within the opening 1410 of the exposure-use field stop 141 and within a region illuminated by the reflecting mirror 130. The reflecting mirror 130 is also rotated (moved) appropriately by using a rotating (moving) mechanism such that the light reflected by the reflecting mirror 130 is applied to a region corresponding to an image height at which a measurement is desired to be taken.

The light that has passed through the opening 1421 is applied to one of the measurement patterns 403 at a position in the object plane corresponding to the opening 1421. In this state, the wavefront aberration of the projection optical system 160 at the foregoing position (image height) is measured.

When the measurement-use field stop 142 is moved leftward, in FIG. 12, by a mechanism configured to move the measurement-use field stop 142 in directions shown as a double-headed arrow 602 in FIG. 12, the wavefront aberration of the projection optical system 160 at any of the positions defined in the directions of the arrow 602 at different image heights can be measured.

Therefore, the measurement-use field stop 142 is moved in an appropriate direction of the double-headed arrow 602 so that the opening 1422 is positioned within the opening 1410 of the exposure-use field stop 141. Subsequently, as described above, the wavefront aberration of the projection optical system 160 at an image height corresponding to the opening 1422 is measured by using the light that has passed through the opening 1422.

Likewise, the wavefront aberrations of the projection optical system 160 at respective image heights corresponding to the openings 1423 to 1425 can be measured by using the foregoing moving mechanism.

According to the second embodiment, since the measurement-use field stop 142 only needs to be moved in a single axial direction, the mechanism that moves the measurement-use field stop 142 can be more simplified than in the first embodiment.

The number, arrangement, shape, and the like of openings in the measurement-use field stop 142 are determined arbitrarily, as described above, depending on the number of positions at which measurements are to be taken, the desired accuracy, and so forth. The shape of the openings may also be determined arbitrarily by configuring the measurement-use field stop 142 as a plurality of movable light-shielding plates.

Another embodiment of the present invention will now be described. This embodiment concerns a method of manufacturing a device (a semiconductor integrated-circuit (IC) device, a liquid crystal display device, and the like) by using the exposure apparatus 100 described above. A device is manufactured through a step of projecting an image of a pattern provided on an original (a mask or a reticle) by exposing a substrate (a wafer, a glass plate, or the like), to which a photoresist is applied, to light by using the exposure apparatus 100, a step of developing the substrate (the photoresist), and other known steps including etching, resist stripping, dicing, bonding, packaging, and so forth. According to the device manufacturing method of this embodiment, a device having higher quality than known ones can be manufactured.

While the present invention has been described with reference to exemplary embodiments, it is to be understood that the invention is not limited to the disclosed exemplary embodiments. The scope of the following claims is to be accorded the broadest interpretation so as to encompass all modifications and equivalent structures and functions.

As many apparently widely different embodiments of the present invention can be made without departing from the spirit and scope thereof, it is to be understood that the invention is not limited to the specific embodiments thereof except as defined in the claims.

This application claims the benefit of Japanese Patent Application No. 2008-102625 filed on Apr. 10, 2008, which is hereby incorporated by reference herein in its entirety.

What is claimed is:

1. An exposure apparatus comprising:
an illumination optical system configured to illuminate a reflective mask with light from a light source; and
a projection optical system configured to project an image of a pattern provided on the reflective mask onto a substrate,
wherein the illumination optical system includes,
a first illuminated-region-defining member configured to define an illuminated region of the reflective mask having the pattern to be projected onto the substrate;
a second illuminated-region-defining member configured to define an illuminated region in which a measurement pattern used in measuring wavefront aberration of the projection optical system is illuminated, the second defining member being able to be inserted into and removed from an optical path of the illumination optical system; and
a condensing mirror configured to condense the light from the first defining member on the pattern to be projected onto the substrate and the light from the second defining member on the measurement pattern,
wherein the illuminated region defined by the second defining member is smaller than the illuminated region defined by the first defining member.

2. The exposure apparatus according to claim 1, wherein the second defining member is a light-shielding member having a pinhole.

3. The exposure apparatus according to claim 1, wherein the second defining member is a light-shielding member having a plurality of openings.

4. The exposure apparatus according to claim 1, wherein the first and second defining members are positioned in an intermediate image plane provided in the illumination optical system.

5. The exposure apparatus according to claim 4, further comprising a movement mechanism configured to move the second defining member within the intermediate image plane.

6. The exposure apparatus according to claim 1, wherein the measurement pattern includes a plurality of pinhole groups.

7. The exposure apparatus according to claim 1, wherein the measurement pattern is provided on the reflective mask.

8. The exposure apparatus according to claim 1, wherein the measurement pattern is provided on a reflective mask other than the reflective mask having the pattern to be projected to the substrate.

9. The exposure apparatus according to claim 1, further comprising:
a light splitter configured to split the light output from the measurement pattern and passing through the projection optical system;
a detector configured to detect interference fringes produced by the light split by the light splitter; and
an arithmetic unit configured to obtain wavefront aberration of the projection optical system from data on the interference fringes detected by the detector.

10. The exposure apparatus according to claim 1, further comprising:
a reflective integrator configured to produce a plurality of secondary light sources by receiving the light from the light source; and
a flat mirror,
wherein either of the reflective integrator and the flat mirror, which are switchable therebetween, is positioned in a plane conjugate to a pupil plane of the projection optical system,
wherein, when the first defining member is positioned in the optical path, the reflective integrator is positioned in the optical path, and
wherein, when the second defining member is positioned in the optical path, the flat mirror is positioned in the optical path.

11. The exposure apparatus according to claim 10, further comprising:
a movement mechanism configured to move the second defining member; and
a rotator configured to rotate the flat mirror,
wherein the second defining member and the flat mirror are moved and rotated by driving the movement mechanism and the rotator, respectively.

12. The exposure apparatus according to claim 1, wherein, when the size of an opening provided in the second defining member is denoted by D; the magnification produced by a section of the illumination optical system that guides the light from the second defining member to an object plane of the projection optical system is denoted by M; and the diameter of a minimum circle enclosing the measurement pattern is denoted by E, a relationship of D=E/M is satisfied.

13. A device manufacturing method to be utilized in an exposure apparatus including an illumination optical system configured to illuminate a reflective mask with light from a light source; and a projection optical system configured to project an image of a pattern provided on the reflective mask onto a substrate, wherein the illumination optical system includes, a first illuminated-region-defining member configured to define an illuminated region of the reflective mask having the pattern to be projected onto the substrate; a second illuminated-region-defining member configured to define an illuminated region in which a measurement pattern used in measuring wavefront aberration of the projection optical system is illuminated, the second defining member being able to be inserted into and removed from an optical path of the illumination optical system; and a condensing mirror configured to condense the light from the first defining member on the pattern to be projected onto the substrate and the light from the second defining member on the measurement pattern, wherein the illuminated region defined by the second defining member is smaller than the illuminated region defined by the first defining member;
the method comprising:
exposing a substrate to light by using the exposure apparatus;
developing the substrate that has been exposed to light; and
forming a device from the substrate that has been developed.
